(19) United States
(12) Patent Application Publication
(10) Pub. No.: US 2007/0115253 A1
(43) Pub. Date: May 24, 2007

(54) Workstation enabler apparatus and related methods and devices

(76) Inventor: Daniel Sandblom, Malmo (SE)

Correspondence Address: MYERS BIGEL SIBLEY & SAJOVEC, P.A., P.O. BOX 37428, RALEIGH, NC, 27627, US

(21) Appl. No.: 11/286,687

(22) Filed: Nov. 23, 2005

(51) Int. Cl. G09G 5/00

(52) U.S. Cl. 345/156; 345/698

(57) ABSTRACT

Methods and devices for adapting media data for visual presentation include obtaining at least one visualization property information of a first visual information presentation device, obtaining media data signal, adapting obtained media data signal, according to the obtained at least one visualization property information, and providing adapted obtained media data signal for enabling presenting the media data by the first visual information presentation device.

### FIELD OF THE INVENTION

The present invention relates to methods and devices for visually presenting media data.

### BACKGROUND

The need to visually presenting media data in electronic devices is increasing with the increased usage of still and moving pictures.

The cellular phones have received an increased processor power, which was until recently found only in regular workstations. As the cellular phones thus have received a competitive processor power, the user interfaces, in the form of keyboards and displays are still small and have not really been designed for allowing user-friendly word processing work.

It is known to connect keyboards, such as full size QWERTY keyboards, to cellular phones, to receive a more user-friendly user interface to the cellular phone.

However, the displays are still small and therefore obstruct using cellular phones as workstations.

There is thus still a need to provide a user-friendly solution to the problem of having to display information on a small cellular phone display.

### SUMMARY OF THE INVENTION

Embodiments according to the invention may solve the problem of presenting media data using external visual information presentation devices. This can be achieved by providing adapting media data signal property for allowing visually presenting the media data.

According to one aspect of this invention, methods for adapting media data for visual presentation include the steps of obtaining visualization property information of a visual information presentation device, obtaining media data signal, adapting obtained media data signal, according to the obtained visualization property information, and providing adapted obtained media data signal, according to the obtained visualization property information, for enabling presenting the media data by the visual information presentation device.

A second aspect of the present invention is directed towards a method including the features of the first aspect, wherein the step of adapting comprises adjusting the media data signal level, according to an obtained visualization signal level information.

A third aspect of the present invention is directed towards a method including the features of the first aspect, wherein the step of adapting comprises adapting picture data, according to obtained visualization resolution information.

A fourth aspect of the present invention is directed towards a method including the features of the first aspect, wherein the step of adapting comprises adapting picture data, according to obtained visualization colour information.

A fifth aspect of the present invention is directed towards a method including the features of the first aspect, wherein the step of adapting comprises adjusting text data, according to obtained visualization text character information.

A sixth aspect of the present invention is directed towards a method including the features of the fifth aspect, wherein the step of adapting comprises adjusting text data, according to obtained visualization line length information.

A seventh aspect of the present invention is directed towards a method including the features of the first aspect, further comprising the step of storing adapted picture data.

An eighth aspect of the present invention is directed towards a method including the features of the seventh aspect, wherein the step of providing comprises recalling the stored adapted picture data.

According to a ninth aspect of the present invention, an electronic adaptation unit is arranged to adapt media data for visual presentation. The electronic adaptation unit includes a media data signal receiving unit, arranged to receive a media data signal, a media data signal adapting unit, arranged to adapt media data according to obtained visualization property information, where the media data signal adapting unit is connected to the media data signal receiving unit, visual information output unit, arranged to provide the obtained media data signal adapted according to obtained visualization property information, where the visual information output unit is connected to the media data signal adapting unit, control unit, connected to the media data signal receiving unit, to the media data signal adapting unit and to the visual information output unit, where the control unit is arranged to control obtaining of visualization property information of a visual information presentation device, control obtaining media data signal, control adapting obtained media data signal and to control providing adapted obtained media data signal, in order to enable presenting visual information on a visual information presentation device.

A tenth aspect of the present invention is directed towards an electronic adaptation unit including the features of the ninth aspect, wherein the media data signal adapting unit further is arranged to adjust the media data signal level according to obtained visualization signal level information.

An eleventh aspect of the present invention is directed towards an electronic adaptation unit including the features of the ninth aspect, wherein the media signal adapting unit further comprises a picture data adapting unit arranged to adapt picture data according to obtained visualization resolution information.

A twelfth aspect of the present invention is directed towards an electronic adaptation unit including the features of the eleventh aspect, wherein the picture data adapting unit further is arranged to adapt picture data according to obtained visualization colour information.

A thirteenth aspect of the present invention is directed towards an electronic adaptation unit including the features of the ninth aspect, wherein the media data signal adapting unit is arranged to adjust text data according to obtained visualization text character information.

A fourteenth aspect of the present invention is directed towards an electronic adaptation unit including the features of the ninth aspect, wherein the media data signal adapting unit is arranged to adjust text data according to obtained visualization line length information.

A fifteenth aspect of the present invention is directed towards an electronic adaptation unit including the features of the ninth aspect, further comprising a memory unit arranged to store the adapted picture data.

A sixteenth aspect of the present invention is directed towards an electronic adaptation unit including the features of the fifteenth aspect, wherein the visual information output unit further is arranged to recall the adapted picture data from the memory unit.

According to a seventeenth aspect of the present invention, a portable communication device is provided. The communication device includes an electronic adaptation unit including the features of the ninth aspect, where the portable communication device comprises a mobile phone.

According to an eighteenth aspect of the present invention, a computer program product is provided comprising a computer readable medium, having thereon computer program code means, to make an electronic adaptation unit or a computer execute, when said computer program code means is loaded to the electronic adaptation unit or in the computer, obtaining of visualization property information of a visual information presentation device, obtaining of media data signal, adapting obtained media data signal, according to the obtained visualization property information, and providing adapted obtained media data signal, according to the obtained visualization property information, for enabling presenting the media data by the visual information presentation device.

In some embodiments, adaptation of visual information may be provided to the properties of the visual information presentation device that is used to visually present the information, and the usage of a cellular phone as a work station may be enabled.

### BRIEF DESCRIPTION OF THE DRAWINGS

The present invention will now be described in more detail in relation to the enclosed drawings, in which:

FIG. 1 schematically shows an electronic adaptation unit, according to one embodiment of the present invention,

FIGS. 2 present a flow chart of a method according to one embodiment of the present invention,

FIG. 3 displays a portable communication device in the form of a cellular phone, according to one embodiment of the present invention,

FIG. 4 illustrates a computer system, enabled with the present invention, and

FIG. 5 displays a computer program product, comprising computer readable program code, when loaded in an electronic adaptation unit or a computer, executes steps according one embodiment of the present invention.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that, although the terms “first”, “second”, etc. may be used herein to describe various elements or components, these elements or components should not be limited by these terms. These terms are only used to distinguish one element or component another element or component. Thus, a “first” element or component discussed below could also be termed a “second” element or component without departing from the teachings of the present invention. The sequence of operations (or steps) is not limited to the order presented in the claims or figures unless specifically indicated otherwise.

Embodiments of the invention are thus directed towards solving the problem of presenting media data using external visual information presentation devices.

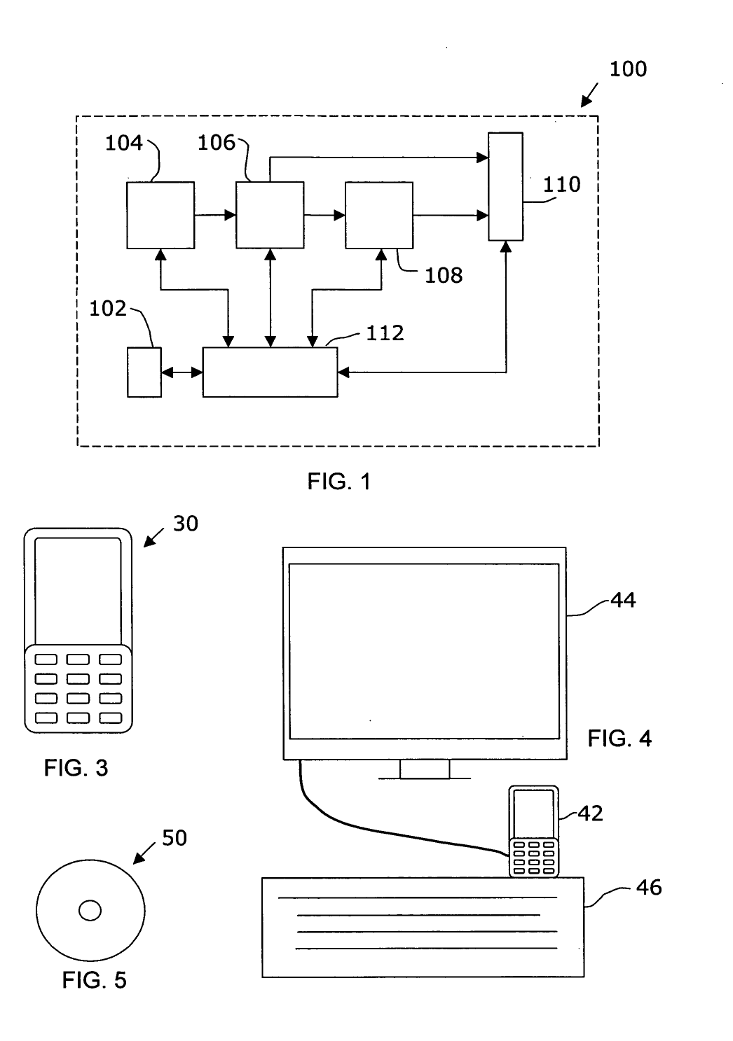

With reference to FIG. 1, schematically an electronic adaptation unit 100 according to one embodiment of the present invention, the invention is now explained in more detail.

Embodiments according to the present invention adapt visual information to the properties of the device that is used to visually present the information.

The electronic adaptation unit 100 in FIG. 1 comprises a visualization property information obtaining unit 102. This unit obtains visualization property information of a visual information presentation device. In order words this unit may obtain information on the resolution of a screen, being one example of a visual information presentation device. Other information that may be obtained is information about the voltage levels of the signal to be displayed by the screen in this example. Other possible information may be information on the size of the screen.

The electronic adaptation unit 100 further comprises a media data signal obtaining unit 104. According to one embodiment of the present invention, this unit is arranged to obtain the media data signal. The media data signal obtaining unit hence obtains information on the signal strength of the media data signal and the media data contents of the media data signal. According to one embodiment of the present invention, this media data signal obtaining unit 104 may comprise a virtual memory in which the media data is obtained.

The electronic adaptation unit 100 also comprises a media data signal adapting unit 106 that is arranged to adapt the media data signal according to the obtained visualization property information obtained by the visualization property information obtaining unit 102.

The media data signal adapting unit 106 being connected to the media data signal obtaining unit 104, is arranged to receive the media data signal from the media data signal obtaining unit 104.

According to one embodiment of the present invention, the media data signal adapting unit 106 is arranged to adapt picture and text data to the properties of the screen, in the example as mentioned above.

Picture data being adapted to the screen properties may be stored in a memory unit 108. Memory unit 108 can hence contain pictures being adapted to the resolution, colour depth etc., being examples of visualization properties, pertinent to a certain screen.

The electronic adaptation unit 100 moreover comprises a visualization information output unit 110 arranged to provide a data signal of the adapted media data. As is shown in FIG. 1, the media data signal adapting unit 106 and the memory unit 108, are connected to the visualization information output unit 110, for the reason of providing adapted text data and picture data, respectively, according to one embodiment of the present invention.

In addition a control unit 112 is also comprised in the electronic adaptation unit 100, according to this embodiment. This control unit 112 is also connected to the other mentioned units in the electronic adaptation unit 100, according to embodiments of the present invention.

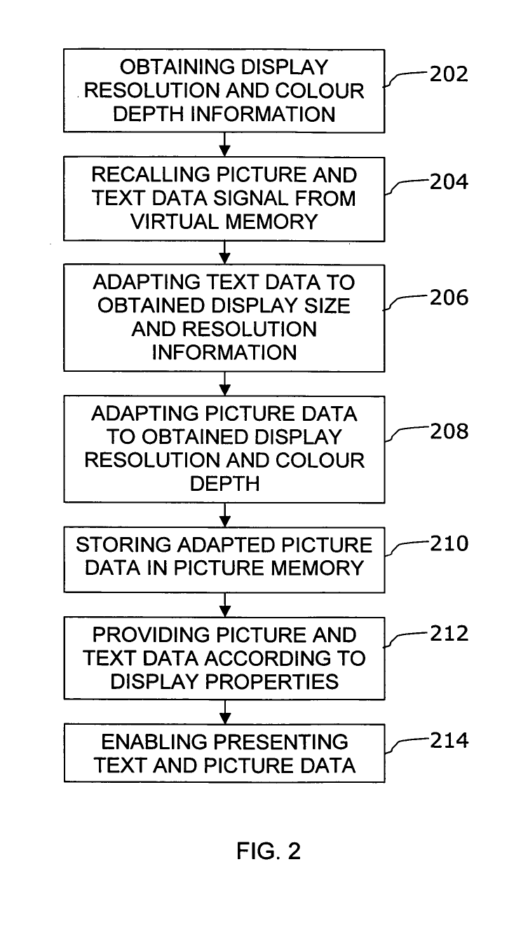

With reference FIG. 2, a flow chart of a method according to embodiments of the present invention will not be described.

According to this embodiment, the method starts with step 202, obtaining display resolution and colour depth information. As described above it may be the visualization property information obtaining unit, which obtains this information.

In order to more clearly illustrate one possible way of using embodiments of the invention, reference is given to FIG. 3 showing a portable communication device in the form of a cellular phone 30, comprising an electronic adapting unit according to embodiments of the present invention. FIG. 4, showing a computer system being enabled according to embodiments of the present invention, comprises the portable communication device 42 of FIG. 3, thus comprising an electronic adapting unit 100, a visual information presentation device 44, in the form of a screen, and a keyboard 46. The portable communication device 42 of this embodiment has a connection to the keyboard 46 and another connection to the screen 44.

Returning to the flow chart of the method according one embodiment of the present invention, obtaining display information may comprise receiving display information from a visual information presentation device. This means that the portable communication device and actually the visualization information property information obtaining unit 102 of the electronic adapting unit 100, may receive display information from the screen, being one example of a visual information presentation device, upon connecting the screen 44 to the cellular phone, 42, again being one example of the portable communication device.

According to this embodiment the visualization property information may thus not be available in the visualization property information obtaining unit 102, prior to connecting the screen 44 to the cellular phone 42.

According to another embodiment of the present invention, the visualization property information may be obtained, from user input unit manoeuvred by a user selecting or setting property information. A user may for instance thus select a resolution of a screen to be 800×640 pixels. Having selected this resolution information, the visualization property information obtaining unit 102, obtains this resolution information in the step of obtaining display resolution and colour depth information, step 202, of the method, according to one embodiment of the present invention.

According to yet another embodiment, visualization property information may be stored in for instance the visualization property information obtaining unit 102, prior to connecting any device with each other. One example in which such an embodiment may be used is in case of providing several output connectors coupled to one or more visualization information output units, thus providing two or more representations of for instance the media data to be visualized. In the case of using a VGA contact, suited for analog signal transmission, one representation may be used, whereas in the case of connecting a screen to a DVI connector, suited for digital transmission, a different representation may be used, to enable visualizing the data to be displayed on the screen connected. In this example the visualization property information obtaining unit 102 may still be responsible for providing the information needed for a successful adaptation of the media data signals.

Having obtained the visualization property information by the visualization property information obtaining unit 102, the step of recalling the picture and text data signal from a virtual memory, follows in step 204, according to one embodiment of the present invention. According to an alternative embodiment the picture and text data signal may be obtained as a streaming media data signal by the media data signal obtaining unit 104, under the control of the control unit 112.

According to an alternative embodiment, the media data signal also comprises video data signals, possibly obtained by the media data signal obtaining unit 104, again controlled by the control unit 112.

Next follows the step of adapting text data to obtained display size and resolution information, step 206, executed by the media data signal adapting unit 106, under the control of the control unit 112, according to one embodiment of the present invention. Having obtained information about the size of the screen or the visual information presentation device, the media data is adapted to this size property. Similarly, the resolution of the visual information presentation device is respected by adapting the text data to the resolution information, to enable presenting the text information on the visual information device.

For the reason of the media data signal comprising picture data, step 208, is thereafter executed by the media data signal adapting unit 106, under the control of the control unit 112.

In case the media data signal, as obtained in step 204, comprises video data signals, the video data is similarly adapted to the obtained display resolution and colour depth of the visual information presentation device, in point or the type being associated with the out connector, as mentioned above.

The visualization property information may comprise a number of different properties, of which the resolution, the colour depth and the screen size are a few only.

According to the embodiment of the flow-chart as presented in FIG. 2, and as indicated in the electronic adaptation unit in FIG. 1, the subsequent step of the method is storing adapted picture data in picture memory, step 210, which step is executed by the memory unit 108 under control of the control unit 112.

In case the media data comprises video data in the method of adapting media data for visual presentation, the adapted video data is stored by the memory unit under the control of the control unit 112, according to an alternative embodiment.

Having adapted the text data and the picture data to the visualization properties of the visual information presentation device, the step of providing the adapted picture and text data according to the display properties, step 212, is executed by the visualization information output unit, under the control of the control unit 112.

The memory unit 108, as used in the embodiment as described above, brings the advantage that adapted picture information can easily be available for presenting purposes. Picture data may hence also be adapted in advance, if available to the media data signal adapting unit in advance.

According to an alternative embodiment of the present invention the adapted picture data is forwarded directly to the visualization information output unit 110, for enabling presenting the visual information, without the need or use of the memory unit 108 for storing adapted picture data in step 210.

Finally, the step of enabling presenting text and picture data suited for the visual information presentation device, step 214, follows. The data has thus been adapted according to the visualization properties as obtained in step 202, by the visualization property information obtaining unit 102.

In addition, FIG. 5 schematically depicts a computer program product 50 according to one embodiment of the present invention, having thereon computer program code means. When the computer program code means, comprised on the computer program product 50, is loaded in a computer or to an electronic adaptation unit, said computer or an electronic adaptation unit, executes the steps of obtaining of visualization property information of a visual information presentation device, obtaining of media data signal, adapting obtained media data signal, according to the obtained visualization property information, and providing adapted obtained media data signal, according to the obtained visualization property information, for enabling presenting the media data by the visual information presentation device.

The computer program product may be provided as a CD-ROM disc according to one embodiment of the present invention. However, the computer program product can alternatively be provided as another type of disc such as a DVD disc, a hard disc, an MD disc, or be provided as a memory or other storage capacity, such as a flash-based memory, for example a memory stick or a USB (Universal Serial Bus) memory or even a memory of the type being volatile.

According to another system exemplifying embodiments of the present invention, the visual information presentation device is comprised by a light projector. Other devices may equally well serve as a visual information presentation device for presenting adapted visual information according to embodiments of the present invention.

According to another embodiment of the present invention is the electronic adaptation unit comprised in a keyboard, to which a cellular phone and a visual information presentation device are connectable.

According to yet another embodiment of the present invention, the electronic adaptation unit is comprised in an external device, to which a cellular phone, a visual information presentation unit and a keyboard may be connectable.

According to still yet another embodiment of the present invention, the electronic adaptation unit is comprised in a cord between for instance the cellular phone and the visual information presentation device. Or possibly, in a connector connectable between the cord from the visual information presentation device and, the cellular phone output connector.

According to still yet another embodiment of the present invention, the steps of the method as described above may be executed in a different order, without deviating from the scope of the invention.

Also, some steps of the method may be omitted, following yet a different embodiment of the present invention.

The number of steps may moreover be changed, by for instance incorporating a few steps in others or dividing the function of certain steps in other steps, such that novel steps are created, without deviating from the essence of the steps.

The function of the units as comprised in the electronic adaptation unit, as presented in FIG. 1, may be realized in another set of interconnected units, according to an alternative embodiments of the present invention.

It is emphasized that embodiments of the current invention can be varied in many ways, of which the alternative embodiments above only are examples of a few. These different embodiments are hence non-limiting examples.

Embodiments of the present invention may thus carry the following overall advantages:

By providing adaptation of visual information to the properties of the visual information presentation device that is used to visually present the information, a variety of different visual information presentation devices may be used to for presenting said visual information.

Moreover, embodiments of the present invention enable the usage of a cellular phone as work station.

Embodiments of the present invention can provide adaptation of visual information to the properties of the visual information presentation device that is used to visually present the information.

The present invention is described herein with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EEPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A method for adapting media data for visual presentation, comprising the steps:
obtaining visualization property information of a visual information presentation device,
obtaining media data signal,
adapting obtained media data signal, according to the obtained visualization property information, and
providing adapted obtained media data signal, according to the obtained visualization property information for enabling presenting the media data by the visual information presentation device.

2. A method according to claim 1, wherein the step of adapting comprises adjusting the media data signal level according to an obtained visualization signal level information.

3. A method according to claim 1, wherein the step of adapting comprises adapting picture data according to obtained visualization resolution information.

4. A method according to claim 1, wherein the step of adapting comprises adapting picture data according to obtained visualization colour information.

5. A method according to claim 1, wherein the step of adapting comprises adjusting text data according to obtained visualization text character information.

6. A method according to claim 5, wherein the step of adapting comprises adjusting text data according to obtained visualization line length information.

7. A method according to claim 1, further comprising the step of storing adapted picture data.

8. A method according to claim 7, wherein the step of providing comprises recalling the stored adapted picture data.

9. An electronic adaptation unit arranged to adapt media data for visual presentation, comprising:
a media data signal receiving unit, arranged to receive a media data signal,
a media data signal adapting unit, arranged to adapt media data according to obtained visualization property information, where the media data signal adapting unit is connected to the media data signal receiving unit,
visual information output unit, arranged to provide the obtained media data signal adapted according to obtained visualization property information, where the visual information output unit is connected to the media data signal adapting unit,
control unit, connected to the media data signal receiving unit, to the media data signal adapting unit and to the visual information output unit, where the control unit is arranged to control obtaining of visualization property information of a visual information presentation device, control obtaining media data signal, control adapting obtained media data signal and to control providing adapted obtained media data signal, in order to enable presenting visual information on a visual information presentation device.

10. An electronic adaptation unit according to claim 9, wherein the media data signal adapting unit further is arranged to adjust the media data signal level according to obtained visualization signal level information.

11. An electronic adaptation unit according to claim 9, wherein the media signal adapting unit further comprises a picture data adapting unit arranged to adapt picture data according to obtained visualization resolution information.

12. An electronic adaptation unit according to claim 11, wherein the picture data adapting unit further is arranged to adapt picture data according to obtained visualization colour information.

13. An electronic adaptation unit according to claim 9, wherein the media data signal adapting unit is arranged to adjust text data according to obtained visualization text character information.

14. An electronic adaptation unit, according to claim 9, wherein the media data signal adapting unit is arranged to adjust text data according to obtained visualization line length information.

15. An electronic adaptation unit according to claim 9, further comprising a memory unit arranged to store the adapted picture data.

16. An electronic adaptation unit according to claim 15, wherein the visual information output unit further is arranged to recall the adapted picture data from the memory unit.

17. A portable communication device comprising a mobile phone, wherein the mobile phone includes an electronic adaptation unit, the electronic adaptation unit comprising:
a media data signal receiving unit, arranged to receive a media data signal,
a media data signal adapting unit, arranged to adapt media data according to obtained visualization property information, where the media data signal adapting unit is connected to the media data signal receiving unit,
visual information output unit, arranged to provide the obtained media data signal adapted according to obtained visualization property information, where the visual information output unit is connected to the media data signal adapting unit, control unit, connected to the media data signal receiving unit, to the media data signal adapting unit and to the visual information output unit, where the control unit is arranged to control obtaining of visualization property information of a visual information presentation device, control obtaining media data signal, control adapting obtained media data signal and to control providing adapted obtained media data signal, in order to enable presenting visual information on a visual information presentation device.

18. A computer program product for adapting media data for visual presentation, the computer program product comprising:
a computer readable medium having computer readable program code embodied therein, the computer readable program code comprising:
computer readable program code that obtains visualization property information of a visual information presentation device,
computer readable program code that obtains a media data signal,
computer readable program code that adapts the obtained media data signal, according to the obtained visualization property information, and
computer readable program code that provides an adapted obtained media data signal according to the obtained visualization property information for enabling presenting the media data by the visual information presentation device.
